(19) United States
(12) Patent Application Publication
(10) Pub. No.: US 2026/0034705 A1
(43) Pub. Date: Feb. 5, 2026

(54) CHISEL SYSTEM

(71) Applicant: Joshua Mason Ferry, Methuen, MA (US)

(72) Inventor: Joshua Mason Ferry, Methuen, MA (US)

(21) Appl. No.: 19/265,186

(22) Filed: Jul. 10, 2025

Related U.S. Application Data
(60) Provisional application No. 63/677,602, filed on Jul. 31, 2024.

(51) Int. Cl. B27F 5/10; B30B 15/02

(52) U.S. Cl. CPC B27F 5/10; B30B 15/02

(57) ABSTRACT

Embodiments of the innovation relate to a chisel system, comprising: a chisel bit having a cutting end and a support end, the support end opposing the cutting end; a chisel bit holder having a first end defining an opening configured to receive the support end of the chisel bit and a second end configured to be secured to a drill press; and a coupling mechanism configured to secure the chisel bit to the chisel bit holder.

### RELATED APPLICATIONS

This patent application claims the benefit of U.S. Provisional Application No. 63/677,602, filed on Jul. 31, 2024, entitled, “Chisel System,” the contents and teachings of which are hereby incorporated by reference in their entirety.

### BACKGROUND

Chisels have been used for centuries by woodworkers to selectively remove wood from a workpiece for a variety of reasons. For example, chisels are conventionally used for joinery to create mortises and tenons, dovetails, and other features requiring the trimming of wood pieces. Also, chisels are used to remove wood to fit elements, such as hinges, locks, and other features, to the workpiece.

Chisels have typically been used as hand tools, which requires the woodworker to gain skill in using the tool over time. For example, woodworkers use hand chisels in paring procedures, where very fine amounts of wood are removed from a workpiece by shaving an area. Further, woodworkers use hand in chopping procedures, that is by hitting the end of the tool with a mallet in order to remove larger amounts of wood from a workpiece.

### SUMMARY

Conventional chisels can suffer from a variety of deficiencies. For example, as provided above, the accurate use of hand chisels requires the user to have a particular level of skill and expertise to create angled (non 90 degree) cuts relative to the face of a workpiece. Without that particular skill level, the user would need to use complicated jigs or other workpiece holding systems to achieve the cut angles desired. Further, absent a given skill level, the user would need to hold a conventional chisel in one hand and a mallet in the other, making it more difficult and dangerous to cut the workpiece as accurately as possible. Additionally, a user may have difficulty in using the hand chisel manually to remove material from a workpiece at a particular depth from the workpiece face. As such, the user can either remove too much or too little material during a chiseling procedure.

By contrast to conventional chisels, embodiments of the present innovation relate to a chisel system. In one arrangement, the chisel system includes a chisel bit holder and chisel blades, or chisel bits, and a coupling mechanism configured to secure the chisel bit to the chisel bit holder. A user can install the chisel system in a conventional drill press and can actuate the drill press to accurately and precisely maneuver the chisel bit relative to a workpiece. As such, the chisel system provides the user with a relatively more precise angle of entry into the material of a workpiece than if performed by hand.

In one arrangement, a chisel system comprises: a chisel bit having a cutting end and a support end, the support end opposing the cutting end; a chisel bit holder having a first end defining an opening configured to receive the support end of the chisel bit and a second end configured to be received and secured by a drill press chuck; and a coupling mechanism configured to secure the chisel bit to the chisel bit holder.

In one arrangement, a workpiece working system comprises: a drill press having a chuck and a quill operatively coupled to the chuck; and a chisel system coupled to the chuck, the chisel system, comprising: a chisel bit having a cutting end and a support end, the support end opposing the cutting end, a chisel bit holder having a first end defining an opening configured to receive the support end of the chisel bit and a second end configured to be secured to the drill press by the chuck, and a coupling mechanism configured to secure the chisel bit to the chisel bit holder.

In one arrangement, a chisel system kit comprises: a plurality of chisel bits, each chisel bit of the plurality of chisel bits having a cutting end and a support end, the support end opposing the cutting end and each cutting end defining a distinct cutting width of the plurality of chisel bits; and a chisel bit holder having a first end defining an opening configured to receive the support end of each chisel bit of the plurality of chisel bits and a second end configured to be secured to a drill press by a drill press chuck.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates of a perspective, exploded view of a chisel system, according to one arrangement.

FIG. 2 illustrates a rear view of the chisel system of FIG. 1, according to one arrangement.

FIG. 3 illustrates a front view of the chisel system of FIG. 1, according to one arrangement.

FIG. 4 illustrates a chisel bit holder of the chisel system of FIG. 1, according to one arrangement.

FIG. 5 illustrates a chisel bit of the chisel system of FIG. 1, according to one arrangement.

FIG. 6 illustrates of a perspective, exploded view of the chisel system of FIG. 1 as presented to a drill press chuck, according to one arrangement

FIG. 7 illustrates the chisel system of FIG. 1 as coupled to a drill press chuck, according to one arrangement.

FIG. 8 illustrates a workpiece working system having the chisel system of FIG. 1, according to one arrangement.

FIG. 9 illustrates a chisel system kit having the chisel system of FIG. 1, according to one arrangement.

### DETAILED DESCRIPTION

Embodiments of the present innovation relate to a chisel system. In one arrangement, the chisel system includes a chisel bit holder and chisel blades, or chisel bits, and a coupling mechanism configured to secure the chisel bit to the chisel bit holder. A user can install the chisel system in a conventional drill press and can actuate the drill press to accurately and precisely maneuver the chisel bit relative to a workpiece.

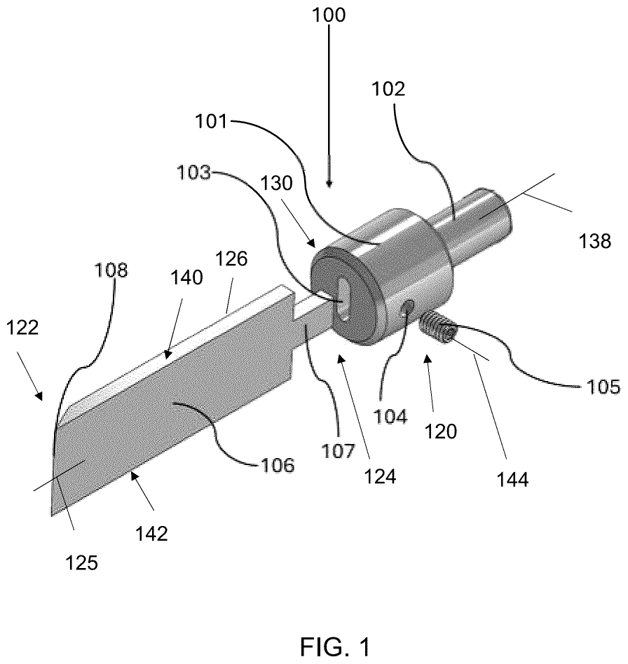

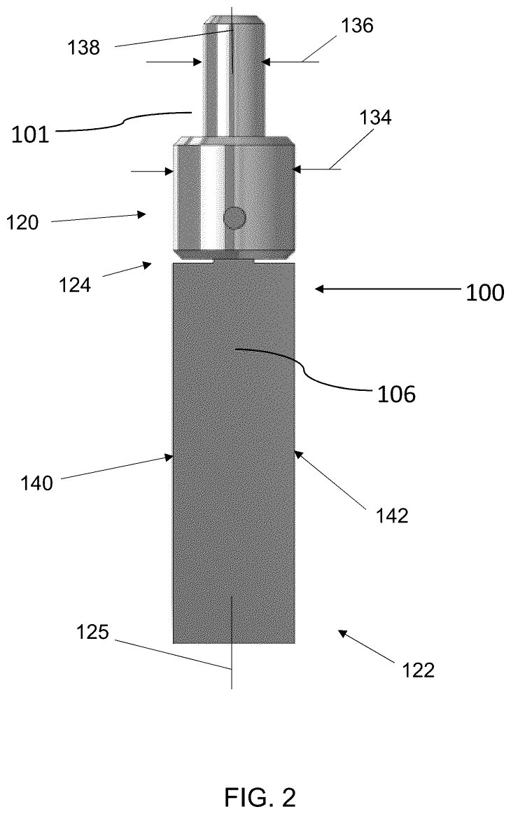

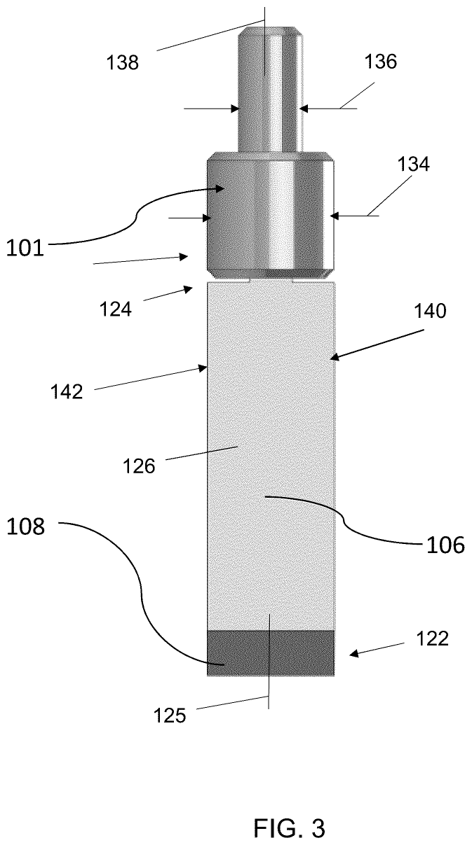

FIGS. 1-3 illustrate a chisel system 100, according to one arrangement. The chisel system 100 includes a chisel bit holder 101, a chisel bit 106, and a coupling mechanism 120 configured to secure the chisel bit 106 to the chisel bit holder 101.

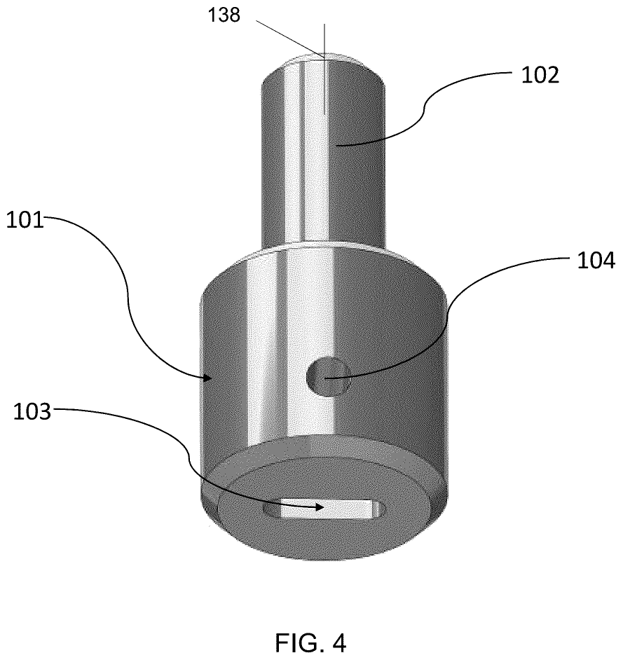

The chisel bit holder 101 is configured to secure the chisel bit 106 within a chuck of a drill press. For example, with additional reference to FIG. 4, the chisel bit holder 101 has a first end 130 that defines an opening 103 configured to receive a portion of the chisel bit 106, as described below. In one arrangement, the opening 103 is configured as a slot, such as a milled slot, having a cross-sectional width and length, as well as a depth, configured to receive a portion of the chisel bit 106 with a relatively tight tolerance. While the first end 130 can be configured in a variety of sizes, in one arrangement the first end 130 has a diameter 134 of ¾ inches.

With continued reference to FIG. 4, the chisel bit holder 101 has a second end 102 configured to be secured to a drill press by a drill press chuck. In one arrangement, the second end 102 of the chisel bit holder 101 has a reduced diameter 136 relative to the first end 130 and is sized to fit within conventional drill press chucks. While the second end 102 can be configured in a variety of sizes, in one arrangement the second end 102 has a diameter 136 of less than ½ inches, such as a diameter 136 of ⅜ inches.

The chisel bit holder 101 can be constructed from a metal material to mitigate bending along a longitudinal axis 138 or otherwise become eccentric to the workpiece during use.

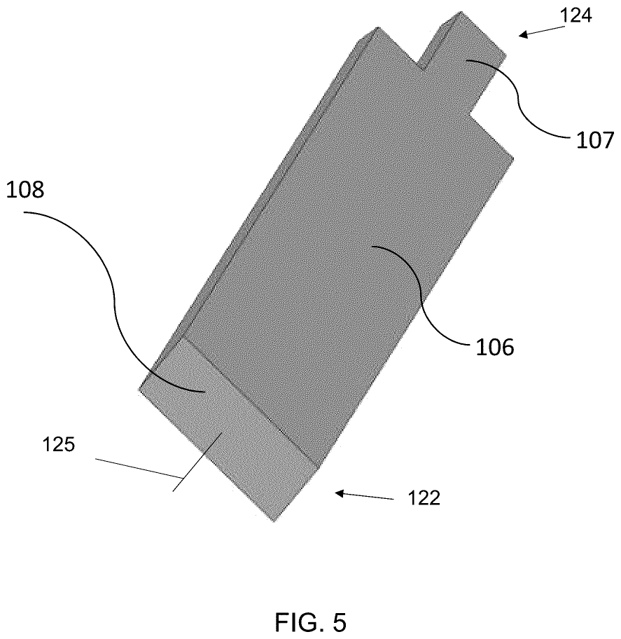

The chisel bit 106 is configured to remove material from a workpiece when utilized s part of the chisel system 100. For example, with additional reference to FIG. 5, the chisel bit 106 has a cutting end 122 and a support end 124 where the support end 124 opposes the cutting end 122 of the chisel bit 106 along a longitudinal axis 125.

The cutting end 122 can be configured with a variety of geometries. In one arrangement, the cutting end 122 defines a bevel 108 sharpened to cut through a user's workpiece material. For example, the bevel 108 can define a specific angle relative to a face 126 of the chisel bit 106 such as an angle between about 25 degrees and 35 degrees. With such a bevel angle, the chisel bit 106 can be utilized for cutting a wood workpiece. It is noted that the bevel 108 can be ground to any angle based upon the user's preference.

The support end 124 is configured to be held by the chisel bit holder 101. In one arrangement, the support end 124 of the chisel bit 106 defines a tang 107 machined with dimensions to fit within the opening 103 defined by chisel bit holder 101 with minimal play and a relatively tight tolerance. For example, the tang 107 of the chisel bit 106 can be sized with a width, length, and depth which corresponds to a width, length, and depth of the opening 103 defined by the chisel bit holder 101. As such, the chisel bit holder 101 can capture the tang 107 of the chisel bit 106 with minimal play.

The chisel bit 106 can be machined from tool steel and can be made in various widths to suit the work required. Further, in one arrangement, opposing sides 140, 142 of the chisel bit 106 can be beveled along the longitudinal axis 125 to improve the cutting ability of the chisel bit 106 when used in relatively narrow or tight areas.

As provided above, the coupling mechanism 120 is configured to secure the chisel bit 106 to the chisel bit holder 101. In one arrangement, the coupling mechanism 120 is configured to secure the support end 124 of the chisel bit 106 within the opening 103 defined by the chisel bit holder 101. For example, the coupling mechanism 120 can include a threaded opening 104 defined by the chisel bit holder 101. As illustrated, a longitudinal axis 1444 of the threaded opening 104 is disposed in an orthogonal orientation relative to the longitudinal axis 138 of the chisel bit holder 101 and perpendicular to the opening 103. The coupling mechanism 120 further includes a set screw 105 disposed in operative communication with the threaded opening 104 defined by the chisel bit holder 101. The set screw 105 is configured to retain the chisel bit 106 within the chisel bit holder 101 by tightening against the chisel bit tang 107 thereby compressing the tang 107 against a wall of the opening 103 defined by the chisel bit holder 101. While a set screw 105 is illustrated as securing the chisel bit 106 to the chisel bit holder 101, other securing mechanisms can be used as well.

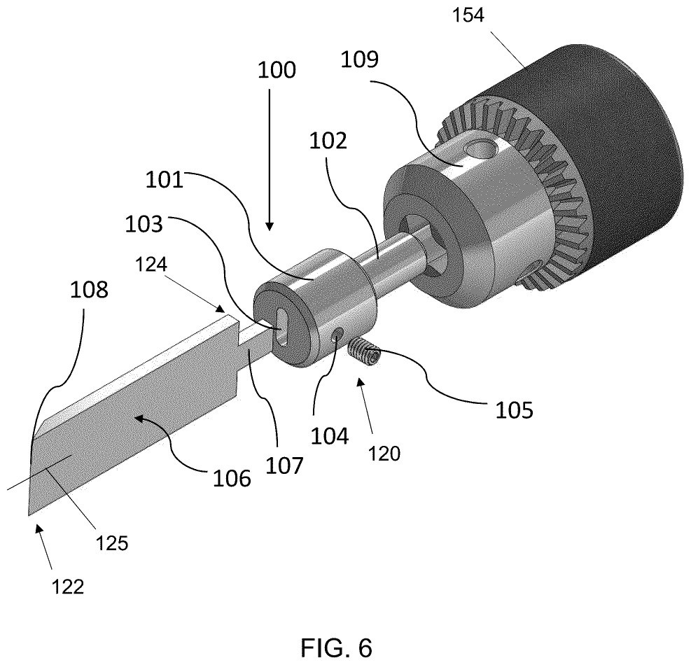

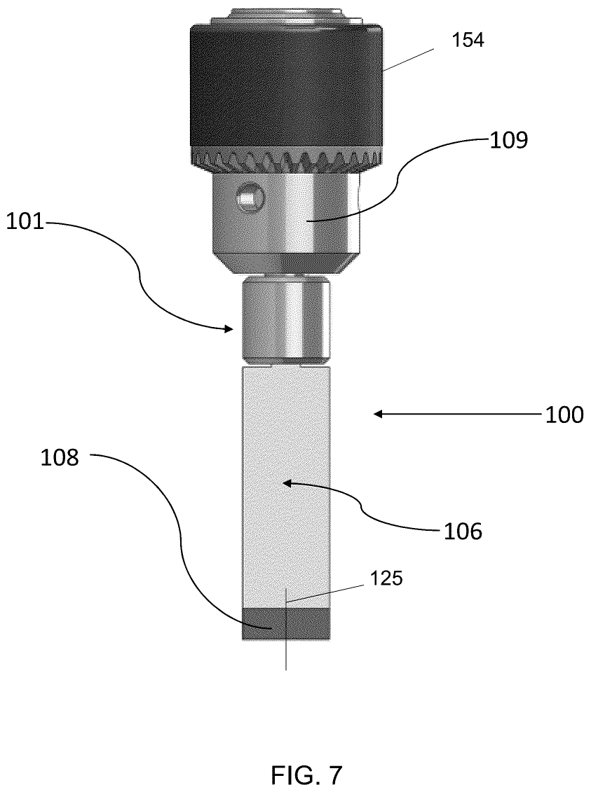

With reference to FIGS. 6 and 7, to assemble the chisel bit system 100 for use, a user can first select a chisel bit 106 with the width desired for the task at hand. Next, the user rotates the set screw 105 in a counterclockwise direction relative to the chisel bit holder 101 so that the user can insert the chisel bit 106 into the opening 103 defined by the chisel bit holder 101. The user then inserts the tang 107 of the chisel bit 106 into the opening 103 such that the tang 107 is seated withing the chisel bit holder 101. Finally, the user rotates the set screw 105 in a clockwise direction relative to the chisel bit holder 101 to dispose the set screw 105 against the tang 107 and to compress the tang 107 against a wall of the opening 103 defined by the chisel bit holder 101. As such, the coupling mechanism 120 secures the chisel bit 106 to the chisel bit holder 101.

The chisel bit 106 is securely held by the chisel bit holder 101 in order for the chisel system 100 to function in a relatively optimum manner. This is due to the fact that, during use of the chisel bit 106 cutting into the material of a workpiece, the chisel bit 106 can get slightly stuck. With a sharp cutting angle, the fibers of the material can grab the steel, and absent the coupling mechanism 120 for holding the chisel bit 106 inside the chisel bit holder 101, the chisel bit 106 could become extracted from the chisel bit holder 101.

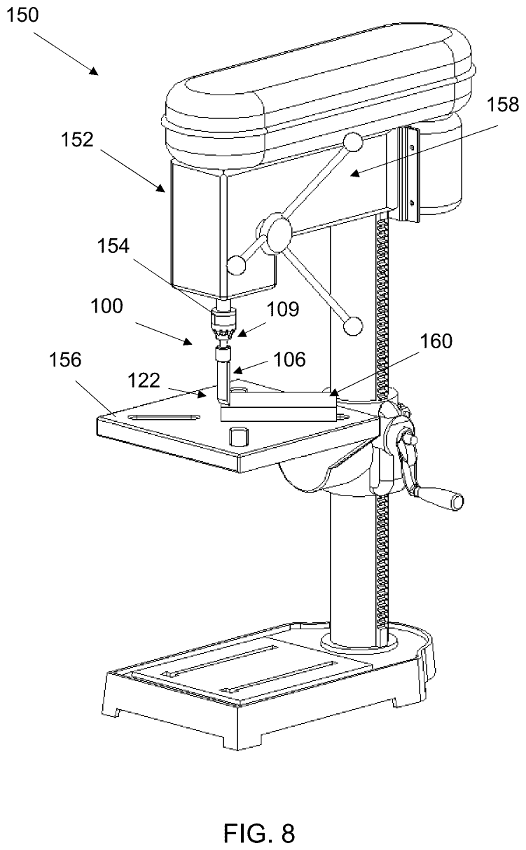

With continued reference to FIGS. 6-8, following assembly of the chisel system 100, the chisel system 100 can be utilized as part of a workpiece working system 150. For example, the user can insert the second end 102 of the chisel bit holder 101 into a chuck 109 of a drill press 152 and can tighten the chuck 109 to secure the chisel system 100 to the drill press 152.

During operation, the user utilizes the drill press 152 in an unpowered state. The user disposes a workpiece 160 onto a drill press work table 156 and in proximity to the cutting end 122 of the chisel blade 106. The user can further manually rotate the chuck 109 within the drill press 152 to match the approach to the workpiece 160 that the user desires (e.g., the orientation of the cutting end 12 relative to the face of the workpiece 160. Next, the user actuates the quill 154 of the drill press 152 using a quill actuating arm 158 to lower the chisel bit 106 into the workpiece. As the user lowers the quill 154 relative to the workpiece 160, the relatively sharp angle of the bevel 108 of the cutting end 12 cuts through the workpiece 160 and the chisel bit 106 sinks into the material, paring it away. Depending on the amount of material desired to be removed from the workpiece 160, the user can continue to actuate and release the quill 154 of the drill press 152 relative to the workpiece 160 until the desired feature is created. By continually lowering and raising the quill 154 with the chisel system 100 installed, the workpiece 160 can be accurately pared.

Accordingly, the workpiece working system 150 provides the user with a relatively precise angle of entry into a workpiece 160, compared to manual chiseling. For example, the drill press 152 can dispose a longitudinal axis 125 of the chisel bit 106 as relatively square to a face of the workpiece 160 or material. Actuation of the quill 154 of the drill press 152 results in a relatively precise 90 degree angle cut relative to the face. Further, conventional drill presses allow the work table to be tilted and secured at a specific non-90 degrees angle. By adjusting the work table 156, actuation of the quill 154 of the drill press 152 results in a relatively precises non-90 degree angle cut relative to the face of the workpiece 160.

Additionally, conventional drill presses are typically equipped with a depth stop that limits the depth of travel of a drill bit into a workpiece. In one arrangement, the user can utilize the depth stop of the drill press 152 in conjunction with the chisel system 100 to set the depth of a cut. For example, if a user wants to limit the depth the chisel bit 106 engages the workpiece 160, the user can set the depth stop to a particular distance to limit the travel distance of the chisel bit 106 into the workpiece.

Further, the workpiece working system 150 provides the user with a level of safety not found with conventional chisels. To pare material with a conventional handheld chisel, the blade is held with only one hand, leaving the nondominant hand vulnerable if the chisel slips out of control. The danger increases to other body parts if the chisel needs to be hit with a mallet.

By contrast, during operation of the workpiece working system 150, the user can utilize a single hand to actuate the quill actuating arm 158 to move the chisel bit 106 relative to the workpiece 160. As such, as the user perform a cut using the chisel system 100, the user has one hand free to hold the workpiece 160, thereby minimizing potential injury. Control of the chisel bit 106, enabled by actuating the chisel system 100 through the quill actuating arm 158, is maintained throughout the paring action. With the chisel bit 106 secured in the chisel bit holder 101, the chisel system 100 mitigates slippage of the chisel bit 106 and harm to the user during operation. Furthermore, the chisel system 100 eliminates the need for a mallet, thereby mitigating possible injury to other parts of the user's body.

Use of the chisel system 100 with a drill press 152 allows a user to create accurate orthogonal (90 degree) cuts and angled (non 90 degree) cuts relative to the face of a workpiece, regardless of the level of skill and expertise of the user and without the need for complicated jigs or other workpiece holding systems. Further, use of the chisel system 100 with a drill press 152 improves user safety, as the user is not required to hold the chisel bit 106 during operation. Additionally, use of the chisel system 100 with depth stop of a drill press 152 allows the user to remove material from a workpiece at a particular depth from the workpiece face. As such, the user can either remove relatively precise amounts of material during a chiseling procedure.

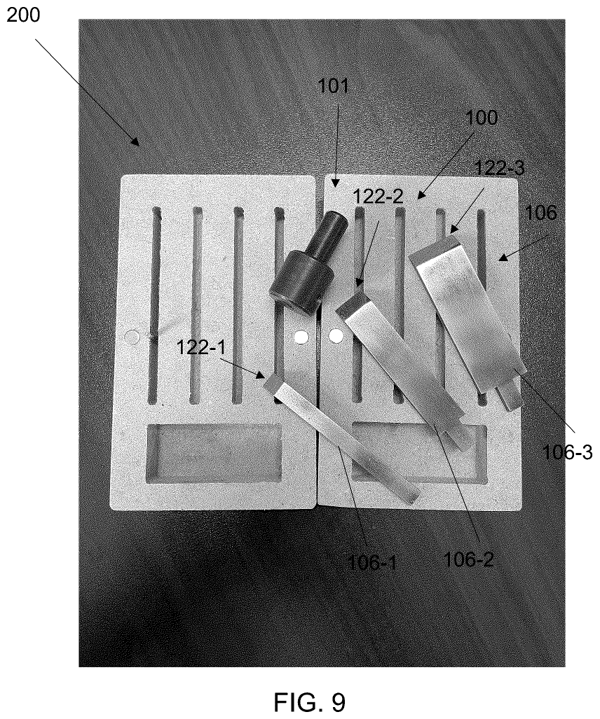

In one arrangement, with respect to FIG. 9, the chisel system 100 can form part of a chisel system kit 200. For example, depending on the application, the chisel system kit 200 can include a chisel bit holder 101 and a plurality of chisel bits 106. Each chisel bit of the plurality of chisel bits 106 includes a cutting end 122 defining a distinct cutting width. For example, as shown in FIG. 9, the chisel system kit 200 includes three chisel bits 106-1 through 106-3 where chisel bit 106-1 has a cutting edge 122-1 having a first width, chisel bit 106-2 has a cutting edge 122-2 having a second width, and chisel bit 106-3 has a cutting edge 122-3 having a third width. The widths can be specified in fractions of an imperial inch (e.g., ¼ inch, ½ inch, ¾ inch, etc.) or in millimeters (e.g., 6 mm, 10 mm, 12 mm, etc.).

While various embodiments of the innovation have been particularly shown and described, it will be understood by those skilled in the art that various changes in form and details may be made therein without departing from the spirit and scope of the innovation as defined by the appended claims.

What is claimed is:

1. A chisel system, comprising:
a chisel bit having a cutting end and a support end, the support end opposing the cutting end;
a chisel bit holder having a first end defining an opening configured to receive the support end of the chisel bit and a second end configured to be secured to a drill press by a drill press chuck; and
a coupling mechanism configured to secure the chisel bit to the chisel bit holder.

2. The chisel system of claim 1, wherein the support end of the chisel bit defines a tang.

3. The chisel system of claim 2, wherein the tang of the chisel bit comprises a width, length, and depth corresponding to a width, length, and depth of the opening defined by the chisel bit holder.

4. The chisel system of claim 1, wherein the first end of the chisel bit holder comprises a diameter of ¾ inches.

5. The chisel system of claim 1, wherein the second end of the chisel bit holder comprises a diameter of less than ½ inches.

6. The chisel system of claim 5, wherein the second end of the chisel bit holder comprises a diameter of ⅜ inches.

7. The chisel system of claim 1, wherein the coupling mechanism is configured to secure the support end of the chisel bit within the opening defined by the chisel bit holder.

8. The chisel system of claim 7, wherein the coupling mechanism comprises:
a threaded opening defined by the chisel bit holder, a longitudinal axis of the threaded opening disposed in an orthogonal orientation relative to a longitudinal axis of the chisel bit holder; and
a set screw disposed in operative communication with the threaded opening defined by the chisel bit holder.

9. A workpiece working system, comprising:
a drill press having a chuck and a quill operatively coupled to the chuck; and
a chisel system coupled to the chuck, the chisel system, comprising:
a chisel bit having a cutting end and a support end, the support end opposing the cutting end,
a chisel bit holder having a first end defining an opening configured to receive the support end of the chisel bit and a second end configured to be secured to the drill press by the chuck, and
a coupling mechanism configured to secure the chisel bit to the chisel bit holder.

10. The workpiece working system of claim 9, wherein the support end of the chisel bit defines a tang.

11. The workpiece working system of claim 10, wherein the tang of the chisel bit comprises a cross-sectional geometry corresponding to a cross-sectional geometry of the opening defined by the chisel bit holder.

12. The workpiece working system of claim 9, wherein the first end of the chisel bit holder comprises a diameter of ¾ inches.

13. The workpiece working system of claim 9, wherein the second end of the chisel bit holder comprises a diameter of less than ½ inches.

14. The workpiece working system of claim 13, wherein the second end of the chisel bit holder comprises a diameter of ⅜ inches.

15. The workpiece working system of claim 9, wherein the coupling mechanism is configured to secure the support end of the chisel bit within the opening defined by the chisel bit holder.

16. The workpiece working system of claim 15, wherein the coupling mechanism comprises:
a threaded opening defined by the chisel bit holder, a longitudinal axis of the threaded opening disposed in an orthogonal orientation relative to a longitudinal axis of the chisel bit holder; and
a set screw disposed in operative communication with the threaded opening defined by the chisel bit holder.

17. A chisel system kit, comprising:
a plurality of chisel bits, each chisel bit of the plurality of chisel bits having a cutting end and a support end, the support end opposing the cutting end and each cutting end defining a distinct cutting width of the plurality of chisel bits; and
a chisel bit holder having a first end defining an opening configured to receive the support end of each chisel bit of the plurality of chisel bits and a second end configured to be secured to a drill press by a drill press chuck.

18. The chisel system kit of claim 17, wherein the support end of each chisel bit of the plurality of chisel bits defines a tang.

19. The chisel system kit of claim 18, wherein the tang of each chisel bit of the plurality of chisel bits comprises a width, length, and depth corresponding to a width, length, and depth of the opening defined by the chisel bit holder.

20. The chisel system kit of claim 18, further comprising a coupling mechanism configured to secure the support end of each chisel bit of the plurality of chisel bits within the opening defined by the chisel bit holder.
